(19) United States
(12) Patent Application Publication
(10) Pub. No.: US 2006/0023818 A1
(43) Pub. Date: Feb. 2, 2006

(54) Image enhancement apparatus and method in wireless system

(76) Inventors: Bong-geun Lee, Suwon-si (KR); Kun-tae Kim, Suwon-si (KR); Dong-hoon Han, Suwon-si (KR)

Correspondence Address: STANZIONE & KIM, LLP, 919 18TH STREET, N.W., SUITE 440, WASHINGTON, DC, 20006, US

(21) Appl. No.: 11/168,511

(22) Filed: Jun. 29, 2005

(30) Foreign Application Priority Data
Jul. 27, 2004 (KR) 2004-58602

(51) Int. Cl. H04L 1/02; H04B 7/10

(52) U.S. Cl. 375/347

(57) ABSTRACT

In a method of wirelessly transmitting an audio and/or video input signal having a standard definition (SD), the input signal is converted to a signal having a high definition (HD) and noise is removed from the converted signal. High definition encoding is performed to the noise-free signal and the encoded signal is wirelessly transmitted. Accordingly, image deterioration can be reduced by eliminating the noise before encoding the input signal. In addition, the HD encoding is performed instead of the SD encoding to reduce image degradation.

### CROSS-REFERENCE TO RELATED APPLICATIONS

This application claims the benefit under 35 U.S.C. § 119 (a) from Korean Patent Application No. 2004-58602, filed on Jul. 27, 2004, in the Korean Intellectual Property Office, the entire disclosure of which is incorporated herein in its entirety by reference.

### BACKGROUND OF THE INVENTION

1. Field of the Invention

The present general inventive concept generally relates to an apparatus and method to generate an audio and/or video signal with a high definition in a wireless system. More particularly, the present general inventive concept relates to an apparatus and method to generate an audio and/or video signal free from noise.

2. Description of the Related Art

With the development of communication technology, wireless communication technology is taking the place of wired communication technology. The wireless communication technology is advantageous over the wired communication technology in some aspects. The wireless communication technology enables a user to obtain desired information conveniently wherever the user is. However, a third person may be able to extract information of the user when the user is using the wireless communication technology. To address this problem, several solutions have been suggested in relation to the wireless communication technology. For example, a signal wirelessly transmitted can be encrypted or scrambled using a scrambling code.

FIG. 1 illustrates a conventional communication system. Referring to FIG. 1, the conventional communication system includes a transmitting end 100 and a receiving end 120. The transmitting end 100 provides an audio and/or video (A/V) signal, and the receiving end 120 receives the A/V signal from the transmitting end 100. Hereinafter, the A/V signal will be referred to as “contents.” The transmitting end 100 includes an A/V processor 104, an encoder 106, and a controller 102. A wireless module access point (AP) 108 is provided to wirelessly transmit the contents. The receiving end 120 includes a controller 122, a display 124, and a decoder 126. A wireless module remote terminal (RT) 128 is provided to receive the contents wirelessly transmitted by the wireless module AP 108.

The A/V processor 104 receives and processes an analog input signal, for example, the A/V signal. The A/V processor 104 includes a tuner (not shown), a NTSC modulator (not shown), and an audio part (not shown). The tuner is used in an input part of a wireless communication receiver. The tuner tunes to a frequency of a certain radio wave or electric signal, and selects and extracts the certain radio wave or electric signal. The NTSC modulator modulates a signal wirelessly received. The audio part extracts an audio component from the received signal. As the A/V processing is irrelevant to the present general inventive concept, it is not described in detail.

The encoder 106 receives the contents from the A/V processor 104 and encodes the received contents according to a control command of the controller 102. The controller 102 gives the control command to the encoder 106 and also controls the A/V processor 104. The wireless module AP 108 wirelessly transfers the contents encoded by the encoder 106. The wireless module AP 108 scrambles the encoded contents in order to protect the contents from a third party during the wireless transmission. Typically, the wireless module AP 108 scrambles data using a scrambling code.

The wireless module RT 128 receives the scrambled contents from the wireless module AP 108. The wireless module RT 128 performs an inverse operation of the wireless module AP 108. That is, the wireless module RT 128 descrambles the received contents using the scrambling code. The scrambling code used at the wireless module AP 108 is the same as the scrambling code at the wireless module AP 108. Accordingly, the wireless module RT 128 can acquire the descrambled encoded contents.

The descrambled encoded contents are supplied to the decoder 126. The decoder 126 decodes the encoded contents. A decoding algorithm performed by the decoder 126 corresponds to an encoding algorithm performed by the encoder 106. Through the decoding, the receiving end 120 can obtain the desired contents. The controller 122 controls the components in the receiving end 120 by sending control commands to the components of the receiving end 120. The display 124 displays the decoded contents according to a control command of the controller 122.

The encoder 106 of the conventional wireless A/V transmission system utilizes standard definition (SD) encoding to encode the analog input signal to be wirelessly transmitted. However, the SD encoding causes deterioration of image quality.

To prevent the deterioration of the image quality due to the SD encoding, high definition (HD) encoding has been suggested. When the HD encoding is carried out without enhancing the image quality of the original A/V signals, the image quality is subjected to the deterioration as in the SD encoding. In the conventional communication system, the image enhancement is infeasible since noise generated during the A/V processing goes through the encoding algorithm at the encoder 106 or the decoding algorithm at the decoder 126. This is because spot noise is transformed to block noise when performing the HD encoding without improving the image quality of the original A/V signal.

### SUMMARY OF THE INVENTION

The present general inventive concept provides an apparatus and method to reduce image deterioration during HD encoding.

The present general inventive concept also provides an apparatus and method to provide a user with improved image quality by removing a noise component generated during HD encoding.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a method to wirelessly transmit an audio and/or video (A/V) input signal, the method including converting the input signal into a signal having a high definition and removing noise from the converted signal, performing high definition encoding to the noise-free signal, and wirelessly transmitting the encoded signal.

The foregoing and/or other aspects of the present general inventive concept may also be achieved by providing a system to wirelessly transmit an audio and/or video (A/V) input signal, the system including an image enhancer to convert the input signal to a signal having a high definition and remove noise from the converted signal, an encoder to perform high definition encoding to the noise-free signal, and a wireless module access point (AP) to wirelessly transmit the encoded signal.

The image enhancer may convert the input signal to the high definition signal by use of 1080 interlaced scanning. The A/V input signal may have a standard definition.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a conventional wireless communication system;

FIG. 2 illustrates a wireless communication system according to an embodiment of the present general inventive concept;

FIGS. 3A and 3B illustrate interlaced scanning and progressive scanning, respectively; and

FIG. 4 illustrates operations of a transmitting end of the wireless communication system of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

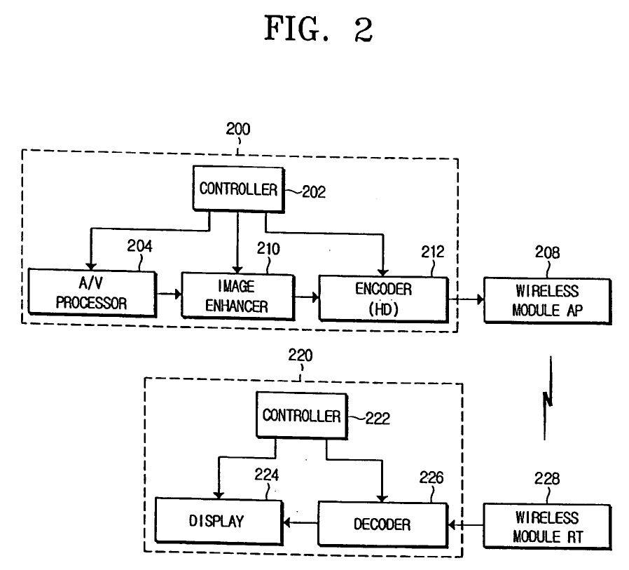

FIG. 2 illustrates a communication system according to an embodiment of the present general inventive concept. Referring to FIG. 2, the communication system includes a transmitting end 200 and a receiving end 220. The transmitting end 200 transmits contents, for example, an A/V signal, and the receiving end 220 receives the contents transmitted by the transmitting end 200. The transmitting end 200 includes an A/V processor 204, an image enhancer 210, an encoder 212, and a controller 202. A wireless module access point (AP) 208 is provided to wirelessly transmit the contents. The receiving end 220 includes a controller 222, a decoder 226, and display 224. A wireless module remote terminal (RT) 228 is provided to receive the contents wirelessly transmitted from the wireless module AP 208.

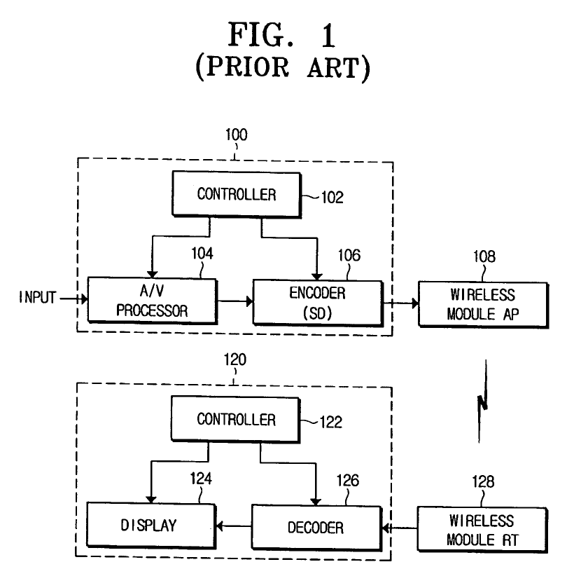

The A/V processor 204 receives the contents from a content provider. The contents can include video information and/or audio information. The A/V processor 204 can be similar to the A/V processor 104 of the conventional communication system of FIG. 1.

The image enhancer 210 converts the received contents to a high definition (HD) signal and removes noise from the HD signal for the sake of an HD encoding operation to be performed by the encoder 212.

The high definition (HD) signal includes a resolution of 1080i (interlaced) or 720p (progressive). The standard definition includes 480p. The image enhancer 210 converts the standard definition signal to the high definition signal with respect to the received contents.

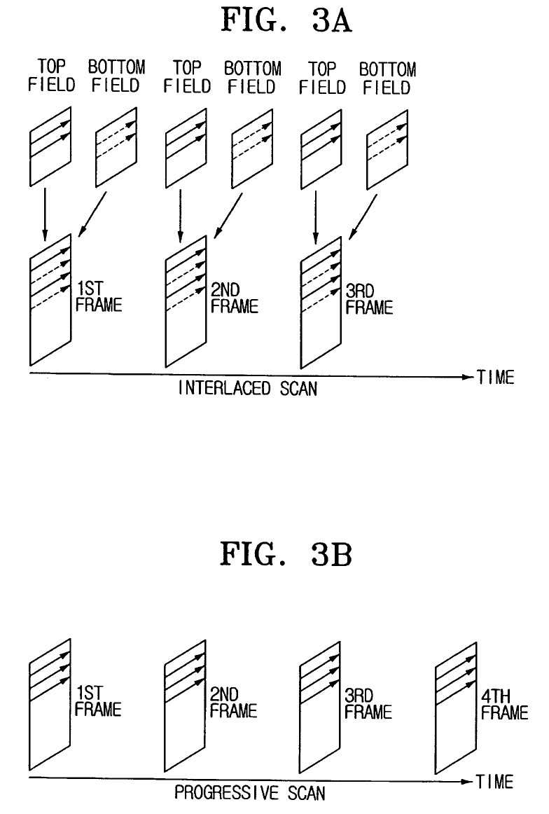

FIGS. 3A and 3B illustrate the interlaced scanning and the progressive scanning, respectively. Particularly, FIG. 3A illustrates the interlaced scanning, and FIG. 3B illustrates the progressive scanning.

To display pictures on a screen, scan lines move from top to bottom and from left to right. Specifically, a first scan line is put on the screen, quickly followed by the next scan line starting from left to right. In such a manner, the pictures can be refreshed on the screen.

Referring to FIG. 3A, the interlaced scanning scans odd-numbered scan lines followed by even-numbered scan lines moving from top to bottom to quickly renew the pictures on the screen. Specifically, first, third, fifth, seventh, etc., scan lines are first scanned in a top field, and then second, fourth, sixth, eighth, etc., scan lines are scanned in a bottom field. Thus, each frame is displayed in two parts (the top field and the bottom field) so as to quickly renew the pictures. The interlaced scanning can quickly create the pictures by refreshing half of the screen at one time. However, the interlaced scanning may cause an image flicker phenomenon with the HD image.

Referring to FIG. 3B, the progressive scanning draws scan lines in a sequence down the screen from top to the bottom, instead of the odd-numbered or the even-numbered lines. Accordingly, the progressive scanning can reduce the image flicker as compared with the interlaced scanning.

As explained above, the interlaced scanning and the progressive scanning can be employed to display HD images using the 1080i and the 720p, respectively. The image enhancer 210 converts the received contents from an SD signal to the HD signal so that the encoder 212 can perform the HD encoding.

The image enhancer 210 then removes noise from the converted contents and provides the noise-free contents to the encoder 212.

The encoder 212 encodes the noise-free contents. According to the embodiment of FIG. 2, the encoder 212 performs the HD encoding on the noise-free contents. The HD encoding can reduce a size of the contents and can reduce a probability of error in scrambling the contents. The encoded contents are provided to the wireless module AP 208.

The controller 202 of the transmitting end 200 controls the A/V processor 204, the image enhancer 210, and the encoder 212. The A/V processor 204, the image enhancer 210, and the encoder 212 carry out the above described operations according to control commands of the controller 202.

The wireless module AP 208 can be located externally from the transmitting end 200 and communicates with the encoder 212 of the transmitting end 200 to receive the encoded contents from the encoder 212. The wireless module AP 208 scrambles the encoded contents received from the encoder 212 to protect the encoded contents from a third party and wirelessly transmits the scrambled contents.

The contents wirelessly transmitted from the wireless module AP 208 are received by the wireless module RT 228. The wireless module RT 228 performs inverse operations to those of the wireless module AP 208. That is, the wireless module RT 228 unscrambles the contents scrambled in the wireless module AP 208. The unscrambled contents are provided from the wireless module RT 228 to the decoder 226 of the receiving end 220.

The decoder 226 decodes the contents provided from the wireless module RT 228. A decoding algorithm used by the decoder 226 to decode the contents corresponds to an encoding algorithm used by the encoder 212 to encode the contents. Accordingly, the decoder 226 can carry out an HD decoding operation. Thus, the receiving end 220 can obtain the noise-free contents. The controller 222 of the receiving end 220 controls the display 224 and the decoder 226 the receiving end 220 by sending control commands to the display 224 and the decoder 226.

The display 224 displays the decoded contents according to a control command of the controller 222.

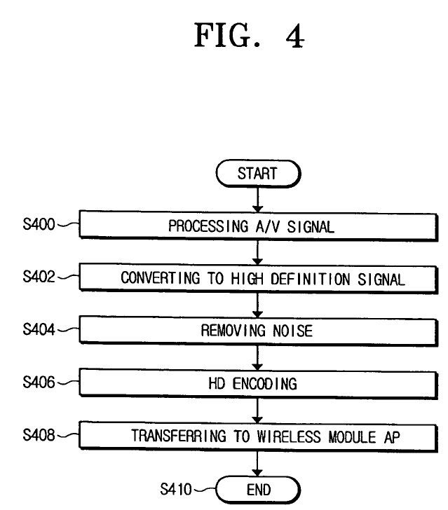

FIG. 4 illustrates operations of the transmitting end 200 of the communication system of FIG. 2 according to an embodiment of the present general inventive concept.

The A/V processor 204 of the transmitting end 200 processes a received A/V signal (S400). The processing of the received A/V signal can include tuning and modulating the received A/V signal.

The image enhancer 210 of the transmitting end 200 then converts the processed A/V signal from an SD signal to an HD signal (S402). The image enhancer 210 of the transmitting end 200 then removes noise from the HD signal (S404). The removal of the noise can prevent deterioration of the HD signal when the HD signal is encoded and transmitted.

The encoder 212 of the transmitting end 200 encodes the noise-free HD signal (S406).The encoder 212 of the transmitting end 200 can perform an HD encoding operation to encode the noise-free HD signal. The transmitting end 200 then transmits the encoded HD signal to the wireless module AP 208 (S408). The transmitting end 200 can transmit the encoded HD signal through the wireless module AP 208, and the wireless module AP 208 can scramble the encoded HD signal before transmitting the encoded HD signal.

According to an embodiment of the present general inventive concept, in order to carry out a high definition (HD) encoding operation on contents received from an audio and/or video (A/V) processor, the contents are converted to an HD image and noise is removed from the HD image.

As described above, image deterioration can be reduced by eliminating noise before encoding an input signal. Furthermore, HD encoding can be performed instead of SD encoding to reduce the image degradation.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of wirelessly transmitting an audio and/or video (A/V) input signal, the method comprising:
converting the A/V input signal to a signal having a high definition and removing noise from the converted signal;
performing high definition encoding to the noise-free signal; and
wirelessly transmitting the encoded signal.

2. The method according to claim 1, wherein the converting of the input signal to the high definition signal comprises:
performing 1080 interlaced scanning to the input signal to have a resolution of 1080.

3. The method according to claim 1, wherein the converting of the input signal to the high definition signal comprises:
performing 720 progressive scanning to the input signal to have a resolution of 720.

4. The method of claim 1, wherein the wirelessly transmitting of the encoded signal comprises:
scrambling the encoded signal; and
wirelessly transmitting the scrambled signal.

5. A wireless communication method, comprising:
wirelessly receiving an encoded HD signal;
decoding the received signal using an HD decoding method which corresponds to an HD encoding method of the encoded signal; and
generating a decoded HD signal.

6. A wireless communication method, comprising:
converting an input A/V signal to a high definition (HD) signal and removing noise from the converted HD signal;
performing high definition encoding to the noise-free HD signal;
wirelessly transmitting the encoded HD signal;
wirelessly receiving the wirelessly transmitted encoded HD signal; and
performing high definition decoding to the encoded HD signal corresponding to the performed high definition encoding to generate the noise-free HD signal.

7. A system to wirelessly transmit an audio and/or video (A/V) input signal, the system comprising:
an image enhancer to convert the A/V input signal to a signal having a high definition and to remove noise from the converted signal;
an encoder to perform high definition encoding to the noise-free signal; and
a wireless module access point (AP) to wirelessly transfer the encoded signal.

8. The system according to claim 7, wherein the image enhancer coverts the input signal to the high definition signal using 1080 interlaced scanning.

9. The system according to claim 7, wherein the A/V input signal comprises:
a standard definition signal.

10. The system according to claim 7, wherein the image enhancer converts the input signal to the high definition signal using 720 progressive scanning.

11. A wireless communication system, comprising:
a signal processing unit to remove noise from a high definition (HD) signal;
an HD encoding unit to encode the noise-free HD signal using HD encoding; and
a wireless module access point (AP) to wirelessly transmit the encoded HD signal.

12. The wireless communication system according to claim 11, wherein the signal processing unit converts an input standard definition (SD) signal into the HD signal.

13. The wireless communication system according to claim 11, wherein the wireless module AP scrambles the encoded HD signal and wirelessly transmits the scrambled signal.

14. A wireless communication system, comprising:
a wireless module access point (AP) to allow remote terminals to access content; and
a content processing unit to convert the content to an high definition (HD) signal, to remove noise from the HD signal, to encode the noise-free HD signal using HD encoding, and to provide the encoded HD signal to the wireless module AP to wirelessly transmit the encoded HD signal.

15. A wireless communication system, comprising:
a transmitting end to convert an input A/V signal to a high definition (HD) signal, to remove noise from the converted HD signal, to perform high definition encoding to the noise-free HD signal, and to wirelessly transmit the encoded HD signal; and
a receiving end to wirelessly receive the wirelessly transmitted encoded HD signal and to perform HD decoding to the received HD signal corresponding to the HD encoding performed by the transmitting end to generate a decoded HD signal.

16. A wireless communication system, comprising:
a transmitting unit to process a high definition (HD) signal to remove noise therefrom, to encode the processed HD signal using HD encoding, and to wirelessly transmit the encoded HD signal; and
a receiving unit to wirelessly receive the encoded HD signal and to decode the received HD signal.

17. The wireless communication system according to claim 16, further comprising:
a wireless module access point (AP) connected to the transmitting unit to wirelessly transmit the encoded HD signal; and
a wireless module remote terminal (RT) connected to the receiving unit to receive the wirelessly transmitted encoded HD signal.

18. The wireless communication system according to claim 17, wherein the wireless module AP scrambles the encoded HD signal and transmits the scrambled signal and the wireless module RT receives the wirelessly transmitted scrambled signal and descrambles the received scrambled signal.

19. The wireless communication system of claim 16, wherein the transmitting unit receives an input standard definition (SD) signal and converts the input SD signal into the HD signal.

20. The wireless communication system of claim 16, wherein the receiving unit comprises a display to display the decoded HD signal.
